(19) United States
(12) Patent Application Publication
(10) Pub. No.: US 2008/0243932 A1
(43) Pub. Date: Oct. 2, 2008

(54) System and method for the production of media

(76) Inventor: Peter Stencel, Rowlett, TX (US)

Correspondence Address: CASH KLEMCHUK POWERS TAYLOR LLP, CAMPBELL CENTRE II, 8150 NORTH CENTRAL EXPRESSWAY, SUITE 1575, DALLAS, TX, 75206, US

(21) Appl. No.: 12/056,885

(22) Filed: Mar. 27, 2008

Related U.S. Application Data
(60) Provisional application No. 60/920,891, filed on Mar. 30, 2007.

(51) Int. Cl. G06F 17/00

(52) U.S. Cl. 707/104.1; 707/E17.009

(57) ABSTRACT

A system and method for the production of media is provided. The system includes a first database of written content submitted by the public and approved by an administrator and a second database of trade professionals, whereby a member of the second database can review the content of the first database, select submitted content from the first database, and assemble a production team from members of the second database to produce media.

### BACKGROUND

1. Field of the Invention

The present invention relates generally to production methods and systems, and in particular to a method and system for producing media appropriate for television or similar distribution.

2. Description of Related Art

Within the media industry, and in particular within the television production market, barriers exist to entry for various trades such as directors, writers, producers, actors, and technical filming staff. These barriers exist because of the current system of producing content appropriate for television or similar media distribution. Conventionally, someone writes a script and tries to sell it. If he is one of the few lucky ones, he sells his work, and after that, a long process of development begins. It often involves finding suitable and available writers, directors, producers, actors, and technical filming staff. The original script undergoes frequent rewriting of the script to satisfy all the decision makers involved in the project. It is also necessary to work around everyone's schedules. To top it all off, everyone involved is represented by an agent. By default, this way of development is cumbersome, time-consuming, and very expensive.

Under the current system, it can also be difficult to enter the market because the cast and crew of successful existing shows are most often complete and there is very little opportunity for new positions on these shows. When a new opportunity does arise, often those with the most previous success and experience are the ones with the best chance of getting the part. The most successful shows are also burdened with increasing costs because of salary demands of the now famous actors and writers. As a result, the shows are still successful but they are not profitable. These shows also are inflexible, in that they appeal generally to one demographic and a sole geographic region. Finally, these successful shows are often incapable of presenting original content to the viewer because the story line is set.

Another problem with current production methods is that cast members are usually represented by agents that tend to increase costs through the demands of each individual and his agent involved in the production.

Finally, if one desires to be a part of producing content suitable for television or other similar media distribution, they must be in close proximity to where this content is produced. Therefore, just about every person aspiring to have a career in content production, including writers, directors, producers, actors, and technical filming staff has to move to Los Angeles or New York in the hope of being successful. The burden of having to be close to the major areas of content production are even greater on actors, where they have to attend auditions for every project that they hope to be a part of.

A need exists, therefore, for a system and method for the production of content that will bring creative minds together but eliminate the unnecessary layers of decision-making, increase flexibility, allow for a broader range of participation, and decrease costs while still producing suitable content for multiple demographics and geographic regions.

All references cited herein are incorporated by reference to the maximum extent allowable by law. To the extent a reference may not be fully incorporated herein, it is incorporated by reference for background purposes and indicative of the knowledge of one of ordinary skill in the art.

### BRIEF SUMMARY OF THE INVENTION

The problems presented in the current media production methods are solved by the systems and methods of the present invention. In accordance with one embodiment of the present invention, a system for the production of media is provided. The system for the production of media includes a first database of written content submitted by the public and approved by an administrator and a second database of trade professionals, whereby a member of the second database can review the content of the first database, select submitted content from the first database, and assemble a production team from members of the second database to produce media. At least one chat forum is provided within the system where members of the second database can discuss various topics, such as potential projects, feedback on produced media, experience working with different members of the second database, and whereby the public can discuss various topics, such as feedback on produced media using the system. Once media is produced using submitted content from the first database by a project team comprised of members of the second database, the produced media is submitted through the system to an administrator for approval. If the administrator approves the produced media, the media is then distributed on a third database where all previous produced media is stored. The media stored on the third database is available for viewing to certain individuals who have subscribed to the system or is free to view by the public.

Other objects, features, and advantages of the present invention will become apparent with reference to the drawings and detailed description that follow.

### BRIEF DESCRIPTION OF THE DRAWINGS

FIG. 1 is an overview schematic of an embodiment of the present invention.

FIG. 2 is a flow chart of an embodiment of the present invention.

FIG. 3 is a flow chart of an embodiment of the present invention.

### DETAILED DESCRIPTION OF THE PREFERRED EMBODIMENT

All references cited herein are incorporated by reference to the maximum extent allowable by law. To the extent a reference may not be fully incorporated herein, it is incorporated by reference for background purposes and indicative of the knowledge of one of ordinary skill in the art.

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

The invention is best understood with a full explanation of one of its embodiments. The embodiment explained is an application of the present invention as it relates to producing a television show, however, one skilled will understand that the present invention is not limited to producing a television show.

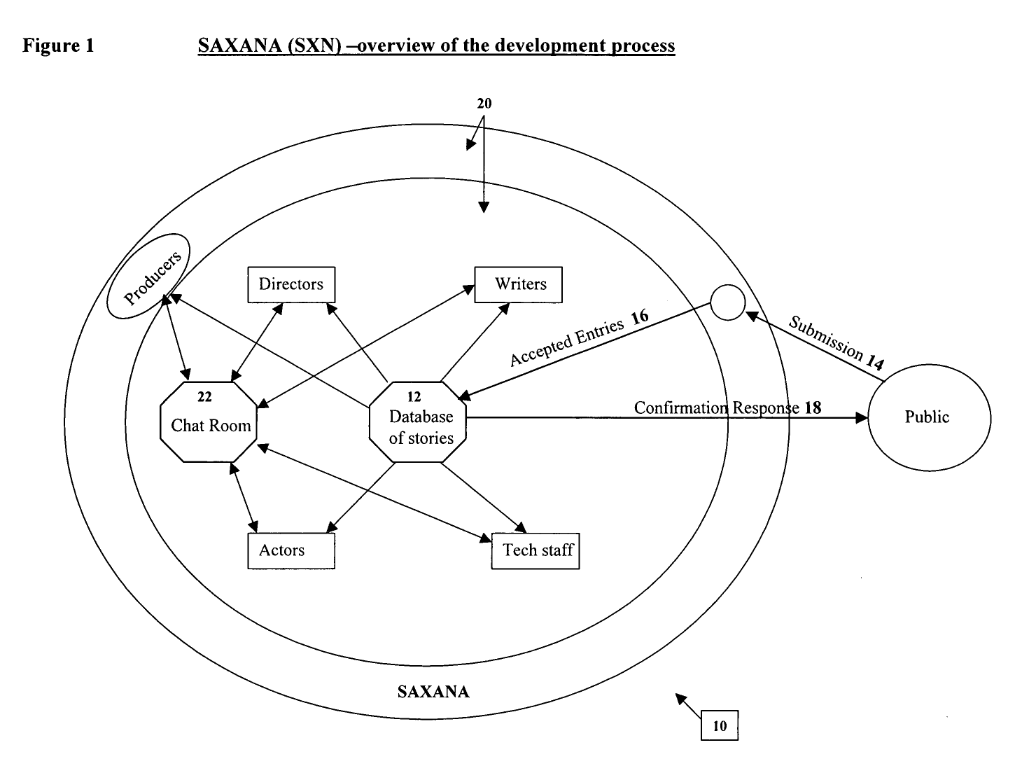

Referring to FIG. 1, an overview schematic of an embodiment of the present invention is provided. The system for the production of media 10 includes a first database 12 that contains content submitted from the public. Because the topic of submitted content is not restricted, the content submitted will provide possibilities of great variety and may be stories of doctors, police officers, parents, children, husbands and wives, teachers and students, and the like. To be included in the first database 12, a user submits his content 14 for consideration for inclusion into the first database 12. The administrator of the system reviews the content for approval and, if approved, stores the content 16 in the first database 12. If the submitted content is rejected, it is removed from the first database 12. In either case, the user receives a confirmation response 18 indicating the content has either been accepted or rejected. The content stored in the database may be sorted by topic, targeted demographic, geographic area, or other criteria. To encourage submission, there may be financial incentives to provide content, such as a payment of a specified sum for content that is chosen and produced using the system.

The system for the production of media 10 includes a second database 20 comprised of trade professionals, or those wishing to be involved in the trade, such as producers, directors, writers, actors, and technical staff. The second database 20 will not be limited to current professionals, but will also include those aspiring to enter the trade, providing the flexibility in staff that is absent from current production methods. The database can be sorted by profession, experience, personal characteristics and traits, and the like. Members of the trade that need to demonstrate their ability will be able to store a sample of their work in their profile within the second database 20. Because profiles are searchable by specific criteria and samples of work are provided, the system of the present invention decreases the need for residing in a certain geographic area and auditioning for every part they hope to attain.

A chat forum 22 may also be provided where members of the second database 20 can discuss various topics, such as potential projects, feedback on produced media, experience working with different members of the second database, and whereby the public can discuss various topics, such as feedback on produced media using the system.

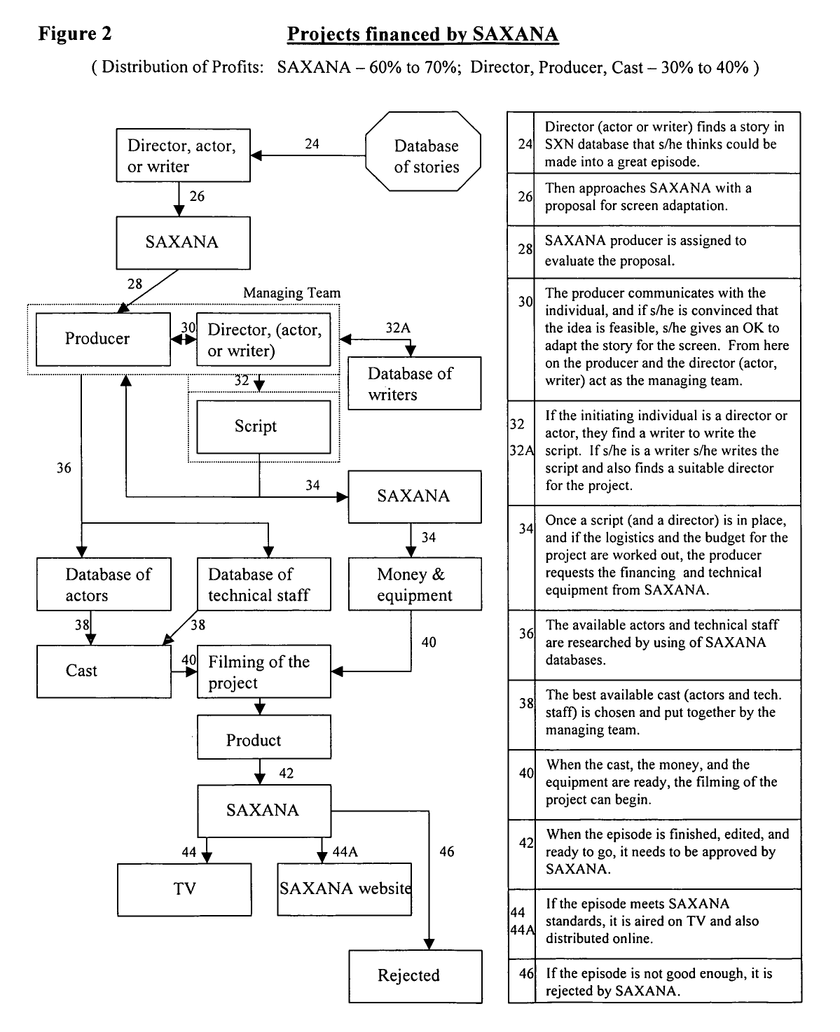

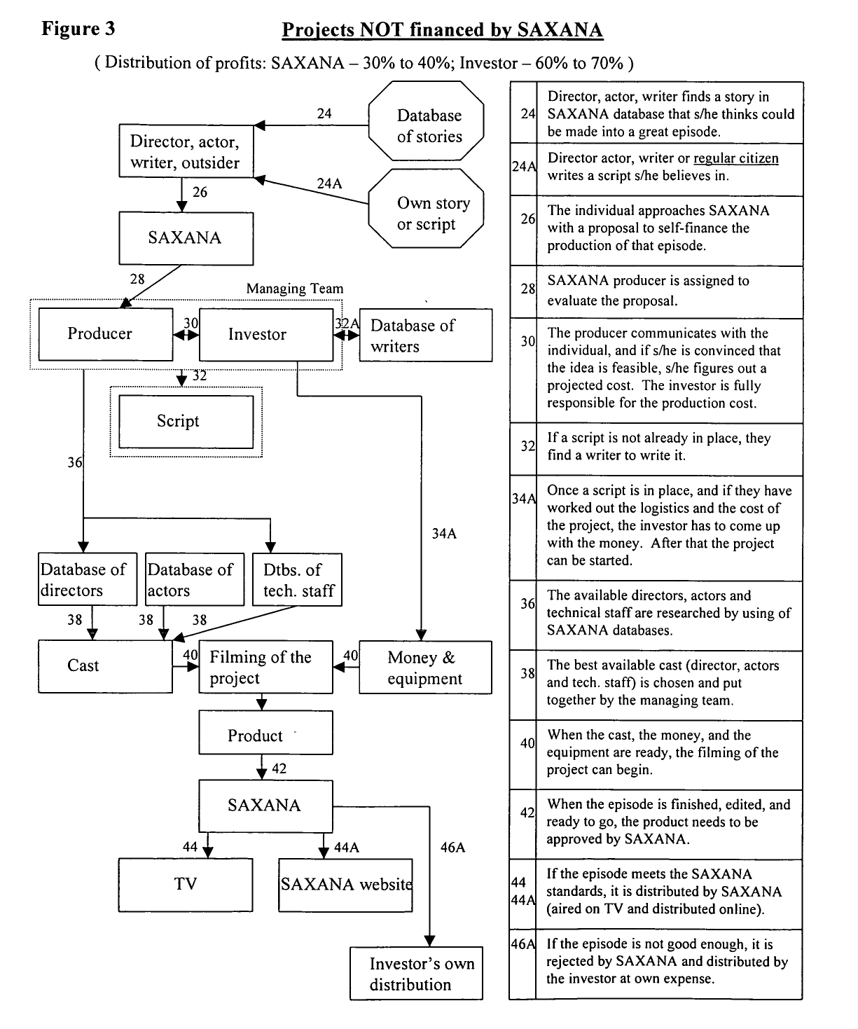

The system for production of media according to the present invention is best explained by demonstrating a specific example of producing media. Referring now to FIGS. 2 and 3, flow charts of embodiments of the present invention are provided. In this example of producing media through the system and method of the present invention, a director decides to embark upon a new project. While the following example provides a director as the impetus for producing new media through the system, it should be understood that the initiator could be a producer, writer, actor, or any similar person who wishes to produce media using the system. The director logs in 24 to the first database 12 of submitted content and is able to review and research the submitted content for a suitable project. When the director discovers content that he is interested in producing, he provides a proposal 26 to the administrator of the system. The person interested in using the system to produce media may also submit a proposal of his own content 24A to the administrator of the system. The administrator, based on his experience or with input from the director, then assigns a producer 28 to review the idea.

If the director demonstrates the feasibility of the idea, and persuades the producer that it is a project worth pursuing, he gets approval 30 to adapt the story for the screen. The director then writes a script 32 himself or finds suitable writers to write the script 32A from the second database of members in the trade or aspiring to be in the trade. After the script has been prepared and approved by both the director and the producer, they prepare a project plan of the logistics for the project (for example, how many actors are needed, how many filming locations will be required, the production cost, and how long it will take to finish it). When the project plan is ready, the plan is submitted to the administrator 34 of the system to provide the funding and equipment necessary to produce the media. The person initiating the project, in this case the director, may also provide his own funding and equipment 34A to produce media using the system.

Once funding has been provided, either by the administrator of the system or the person initiating the project, the director returns to the second database 20 to assemble a project team, which may include actors and technical filming staff suitable for the project. Using the search features of the second database 20, the director can search for team members 36 that meet his specific criteria. For example, he may be looking for a 25 year old actress with a slim build, blond hair, who is Caucasian, and has martial arts skills. The database provides results where each result is a detailed profile of an actor and may include a biography, previous credits in TV or theater projects, photo shots, and video from an audition or previous work. From the results of the research conducted on the second database 20, the director assembles the whole cast and crew 38 to produce the media.

Once the cast and crew are assembled, the director and producer combine the funding and equipment with the cast and crew and the initial media is produced 40. In the example of a television show, the actual filming may take 15-20 days on average because the stories will be straight forward, they will require only few shooting locations, and most of the time there will not be too many characters. Developing an idea and assembling the cast and crew in this manner will provide a production process that cuts through the layers of decision-making that are present in current production systems and provide the flexibility and variety that is needed to produce new and interesting media to multiple demographics in differing geographic locations.

After the initial production of the media is completed, in this case the filming of the television show, the director and the producer edit the episode and present it to the administrator of the system for approval 42. If the finished media produced using the system is approved, the produced media is distributed by the administrator either through established communication methods 44 or through a third database 44A in which media produced using the system is provided for viewing and commentary, either on a fee basis or for free. If the finished media produced using the system is not approved by the administrator, and the production costs were funded by the administrator, the produced media is rejected 46. If the finished media produced using the system is not approved by the administrator, and the production costs were funded by a member or members of the project team, the produced media is rejected by the administrator of the system for distribution through its channels and the member of the team that provided the funding is free to distribute the produced media 46A through any means that may be available. Producing content using the method and system of the current invention will decrease the costs of production and ensure predictability. Because the best available team is assembled for each project and, once the media is produced, dissolved, desirable media can be produced on an ongoing basis without being subject to the demands of the members of the team, their agents, or an inflexible story line.

Once the media has been produced, and regardless of how it is distributed, the members of the production team can then return to the system and provide input on their experience working with other members of the team and provide their thoughts on the project, either directly into the second database 20 of members or on a chat forum 22. In a similar fashion, the public can provide feedback on the media that they have seen or heard on a chat forum.

Even though many of the examples discussed herein are applications of the present invention in producing a television show, the present invention also can be applied to other types of media content, including but not limited to audio production, video production for other venues such as movies and plays, as well as other media content.

It should be apparent from the foregoing that an invention having significant advantages has been provided. While the invention is shown in only a few of its forms, it is not just limited but is susceptible to various changes and modifications without departing from the spirit thereof.

I claim:

1. A system for the production of media comprising:
A first database of written content submitted by the public and approved by an administrator; and
A second database of trade professionals, whereby a member of the second database can review the content of the first database, select submitted content from the first database, and assemble a production team from members of the second database to produce media.

2. The system for the production of media according to claim 1 wherein:
The system includes a chat forum where members of the second database can discuss various topics, such as potential projects, feedback on produced media, experience working with different members of the second database, and whereby the public can discuss various topics, such as feedback on produced media using the system.

3. The system for the production of media according to claim 1 wherein:
Produced media using the system is submitted to an administrator for approval before distribution.

4. The system for the production of media according to claim 1 wherein:
Produced media is distributed by the administrator of the system.

5. The system for the production of media according to claim 1 wherein:
A third database is included whereby produced media is available for viewing.

6. The system for the production of media according to claim 1 wherein:
The administrator provides funding to produce the media based on the submitted content from the first database for the project team comprised of members of the second database.

7. The system for the production of media according to claim 1 wherein:
The project team members provide funding to produce the media based on the submitted content from the first database for the project team comprised of members of the second database.

8. The system for the production of media according to claim 1 wherein:
The person submitting content to the first database that is produced by members of the second database are compensated for providing the content.

9. The system for the production of media according to claim 3 wherein:
Produced media is distributed by the administrator of the system after approval.

10. The system for the production of media according to claim 9 wherein:
A third database is included whereby produced media is available for viewing.

11. A system for the production of media comprising:
A first database of written content submitted by the public and approved by an administrator;
A second database of trade professionals, whereby a member of the second database can review the content of the first database, select submitted content from the first database, and assemble a production team from members of the second database to produce media;
a chat forum where members of the second database can discuss various topics, such as potential projects, feedback on produced media, experience working with different members of the second database, and whereby the public can discuss various topics, such as feedback on produced media using the system;
Produced media using the system is submitted to an administrator for approval before distribution;
Produced media that is approved is then distributed by the administrator of the system; and
A third database is included whereby produced media is available for viewing.

12. The system for the production of media according to claim 11 wherein:
The administrator provides funding and equipment to produce the media based on the submitted content from the first database for the project team comprised of members of the second database.

13. The system for the production of media according to claim 11 wherein:
The project team members provide funding and equipment to produce the media based on the submitted content from the first database for the project team comprised of members of the second database.

14. A method for the production of media comprising the steps of;
Providing a first database of written content submitted by the public and approved by an administrator;
Providing a second database of trade professionals;
Selecting submitted content from the first database;
Assembling a project team from members of the second database to produce media; and
Producing media based on the submitted content from the first database with the project team assembled from the second database.

15. The method for the production of media according to claim 14 wherein:
After the producing step, submitting the produced media to an administrator for approval for distribution; and,
distributing the media.

16. The method for the production of media according to claim 14 wherein:
After the providing the second database step, providing a third database for produced media; and
After the producing step, distributing the produced media onto the third database.

17. The method for the production of media according to claim 14 wherein:
After the providing the second database step, providing a chat forum; and
Posting on the chat forum regarding various topics, such as potential projects, feedback on produced media, experience working with different members of the second database, and public feedback on media that has been produced and distributed using the method;

18. The method for the production of media according to claim 14 wherein:
After the assembling step, planning a budget and timeline for the production of media using the system; and
Attaining funding and equipment from the administrator of the system to produce the media based on the submitted content from the first database for the project team comprised of members of the second database.

19. The method for the production of media according to claim 14 wherein:
After the assembling step, planning a budget and timeline for the production of media using the system; and
Providing self-funding and equipment to produce the media based on the submitted content from the first database for the project team comprised of members of the second database

20. The method for the production of media according to claim 15 wherein:
After the providing the second database step, providing a third database for produced media; and
After the distributing step, distributing the produced media onto the third database.
